(19) United States
(12) Patent Application Publication
(10) Pub. No.: US 2007/0141422 A1
(43) Pub. Date: Jun. 21, 2007

(54) Fuel cell component having an electrolyte dopant

(75) Inventor: Nancy E. Brown, New Braintree, MA (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN CERAMICS & PLASTICS, INC., Worcester, MA (US)

(21) Appl. No.: 11/365,464

(22) Filed: Mar. 1, 2006

Related U.S. Application Data
(63) Continuation-in-part of application No. 11/305,311, filed on Dec. 16, 2005.

(51) Int. Cl. H01M 8/12; H01M 4/90

(52) U.S. Cl. 429/30; 429/33; 429/44

(57) ABSTRACT

The present disclosure is directed to a fuel cell component having a cathode including a ceramic material that includes an A-site deficient, perovskite crystal structure and a cation species bonded to oxygen. The fuel cell component further includes an anode and an electrolyte layer disposed between the cathode and the anode. The electrolyte layer includes a base material and an electrolyte dopant that includes the cation species of the cathode.

### CROSS-REFERENCE TO RELATED APPLICATION(S)

The present application is a continuation-in-part of U.S. application Ser. No. 11/305,311, filed Dec. 16, 2005, the subject matter thereof being incorporated herein by reference in its entirety.

### BACKGROUND

1. Field of the Disclosure

The present invention generally relates to solid oxide fuel cells (SOFCs).

2. Description of the Related Art

In pursuit of high-efficiency, environmentally friendly energy production, solid oxide fuel cell (SOFC) technologies have emerged as a potential alternative to conventional turbine and combustion engines. SOFCs are generally defined as a type of fuel cell in which the electrolyte is solid metal oxide (desirably non-porous or limited to closed porosity), in which O²⁻ is transported from the cathode to the cathode/electrolyte interface. Fuel cell technologies, and particularly SOFCs, typically have a higher efficiency and have lower CO and NOx emissions than traditional combustion engines. In addition, fuel cell technologies tend to be quiet and vibration-fee. Solid oxide fuel cells (SOFCs) have an advantage over other fuel cell varieties. For example, SOFCs may use fuel sources such as natural gas, propane, methanol, kerosene, and diesel, among others because SOFCs operate at high enough operating temperatures to allow for internal fuel reformation. However, challenges exist in reducing the cost of SOFC systems to be competitive with combustion engines and other fuel cell technologies. These challenges include lowering the cost of materials, improving degradation or life cycle, and improving operation characteristics such as current and power density.

In the context of long-term operational characteristics of SOFCs, conductivity degradation is a notable parameter that should be addressed to enable formation of commercially viable components. Generally, degradation of has been attributed to a variety of influences, such as changes in the crystalline structure of the solid electrolyte, reaction of the electrolyte with impurities, as well as on-and-off cycling leading to cracks and flaws within the electrolyte layer. Lost conductivity, increases in resistivity, and degradation of contact surface also lead to a reduction in operating voltages and current densities, negatively impacting the performance of the fuel cell, including reduction of the power output. As a result of performance degradation, expensive fuel cell components are replaced more frequently, leading to higher overall energy costs.

It has been suggested that particular electrode compositions improve the lifetime of the SOFC by delaying the formation of conductivity limiting compositions. For example, an A-site deficient LSM cathode composition may slow the formation of LZO at the cathode/electrolyte interface. See, Mitterdorfer and Gauckler, “La₂Zr₂O₇ formation and oxygen reduction kinetics of the La_{0.85}Sr_{0.15}Mn_{y}O₃, O_{2(g)}/YSZ system” Solid State Ionics, Elsevier Science (1998). See also, S. P. Jiang, “Issues on the development of (La,Sr)MnO₃ cathod for solid oxide fuel cells” Journal of Power Sources, Elsevier (2003), available at, www.elsevier.com/locate/jpowsour. However, such compositions have only limited impact on attenuating the formation of LZO and the degredation of the fuel cell.

As such, improvements are still needed as many typical fuel cell systems suffer from deficiencies in providing a low cost alternative to other energy sources. In view of the foregoing, it is considered generally desirable to provide improved SOFC designs suitable for use in demanding SOFC applications.

### BRIEF DESCRIPTION OF THE DRAWINGS

The present disclosure may be better understood, and its numerous features and advantages made apparent to those skilled in the art by referencing the accompanying drawings.

FIG. 1 is a cross-sectional illustration of a fuel cell component in accordance with an embodiment disclosed herein.

FIG. 2 is a cross-sectional illustration of a fuel cell component in accordance with an embodiment disclosed herein.

FIG. 3 is a cross-sectional illustration of a fuel cell stack in accordance with an embodiment disclosed herein.

FIG. 4 illustrates an SOFC system in accordance with an embodiment disclosed herein.

The use of the same reference symbols in different drawings indicates similar or identical items.

### DESCRIPTION OF THE PREFERRED EMBODIMENT(S)

According to one aspect, a fuel cell component is provided that includes a cathode comprising a ceramic material, the ceramic material having an A-site deficient, perovskite crystal structure and comprising a cation species bonded to oxygen. The fuel cell component further includes an anode and an electrolyte layer disposed between the cathode and the anode. The electrolyte layer includes a base material and an electrolyte dopant, wherein the electrolyte dopant comprises the cation species of the cathode.

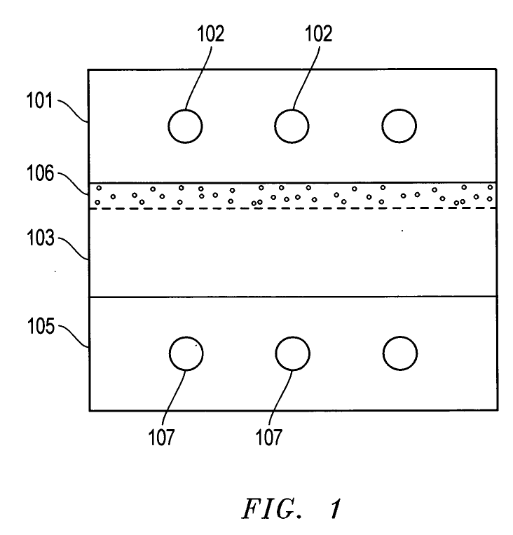

Referring to FIG. 1, a cross-sectional view of a fuel cell component is illustrated having a cathode 101, electrolyte 103, an electrolyte dopant layer 106, and an anode 105. Referring to the anode 105 of the SOFC, the anode 105 is the electrode that facilitates oxidation of the fuel in the redox reaction that generates a current within the SOFC device. The anode 105 is referred to as the fuel electrode since it typically transports a fuel gas, such as hydrogen (H₂), through the anode material to the anode/electrolyte interface where the oxidation reaction occurs. The fuel gas can be supplied to the anode 105 via channels 107. The channels 107 are typically positioned in close proximity to the anode to provide effective transport of the fuel gas from the channels 107, through the anode material, and ultimately to the anode/electrolyte boundary. Additionally, a high volume of porosity in the anode 105 aids rapid transport of the fuel gas to the anode/electrolyte interface for oxidation. According to one embodiment, the percent porosity of the anode is not less than about 5.0 vol. % of the total volume of the anode 105. According to another embodiment, the percent porosity of the anode 105 is not less than about 15 vol. %, such as not less than about 20 vol. %, 30 vol. %, or even not less than about 40 vol. %. Still, the percent porosity of the anode 105 is particularly within a range of between about 15 vol. % and 40 vol. %.

According to one embodiment, the anode 105 comprises a cermet material, that is, a two-phase combination of a ceramic and metallic material. For example, the anode 105 may include nickel and yttria-stabilized zirconia or nickel and gadolinium oxide-stabilized ceria. The nickel is generally produced through the reduction of nickel oxide included in the anode precursor, such as a green ceramic composition that is heat-treated.

Referring to the cathode 101, the cathode 101 facilitates the reduction of oxygen for the redox reaction within the SOFC. Similar to the anode 105, the cathode 101 is a porous material for facilitating the flow of gas, which aids the transport of an oxygen-rich gas through the cathode material to the cathode/electrolyte interface to fuel the reduction reaction. Typically, the gas flowing through the cathode 101 includes oxygen, such air or another oxygen-rich gas. Generally, the oxygen-rich gas is supplied to the cathode 101 via channels 102. The position of the channels 102 relative to the cathode 105 may vary depending upon the type of delivery system. Typically, the channels 102 are positioned within close proximity to the cathode to provide effective transport of the oxygen-rich gas from the channels 102, through the porous cathode material, and ultimately to the cathode/electrolyte interface. Additionally, a high volume of porosity in the cathode 101 aids rapid transport of the fuel gas to the anode/electrolyte interface for oxidation. According, to one embodiment as illustrated in FIG. 1, the channels 102 are incorporated within the cathode 101. According to one embodiment, the percent porosity of the cathode 101 is not less than about 5.0 vol % of the total volume of the cathode 101. In another embodiment, the percent porosity of the cathode 101 is greater, such as not less than about 15 vol. %, 20 vol. %, 30 vol. %, or still not less than about 40 vol. %. Still, the percent porosity of the anode 105 is particularly within a range of between about 15 vol. % and 40 vol. %.

As stated previously, the cathode 101 may be made of a lanthanum manganate material having a general composition of, (La₁₋ₓAₓ)_{y}MnO_{3-δ}, wherein y is less than about 1.0. Particularly, the cathode 101 can be made of a lanthanum manganate material including a substituted species, giving the cathode composition a perovskite type crystal structure where the La is partially substituted by “A” on the A-sites of the perovskite crystal structure. According to one embodiment, A includes a divalent cation species, for example elements such as Mg, Ba, Sr, Ca, Co, Ga, Pb, and Zr As such, according to a particular embodiment, the substituted species, A is Sr, and the cathode material is a lanthanum strontium manganate material, referred to herein as LSM.

Referring to the stoichiometry of the lanthanum manganate cathode material, according to one embodiment, parameters such as, the type of atoms present, the percentage of vacancies within the crystal structure, and the ratio of atoms within the cathode material affect the rate of formation of conductivity-limiting compositions at the cathode/electrolyte interface during the operation of the fuel cell. The formation of conductivity-limiting compositions reduces the efficiency and operable lifetime of the SOFC.

As previously described, in one aspect, the composition of the lanthanum manganate cathode is (La₁₋ₓAₓ)_{y}MnO_{3-δ}, wherein y is less than about 1.0, x is not greater than about 0.5, and the ratio of La/Mn is less than about 1.0. The value of y in the general formula (La₁₋ₓAₓ)_{y}MnO_{3-δ} represents the percent occupancy of atoms on the A-site within the crystal lattice. Thought of another way, the value of y may also be subtracted from 1.0 and represents the percentage of vacancies on the A-site within the crystal lattice. The cathode compositions provided herein includes a substituted lanthanum manganate material having a value of y less than 1.0, or in other words, an “A-site deficient” structure, since the A-sites within the crystal structure are not 100% occupied. According to one embodiment, y is not greater than about 0.95, such as not greater than about 0.90, 0.88, or even not greater than about 0.85. In a particular embodiment, the cathode 101 is LSM (the cathode substitutional “A” component is Sr) having a composition of (La₁₋ₓSrₓ)_{y}MnO_{3-δ}, where y is less than about 1.0, such as not greater than about 0.95, 0.90 or even not greater than about 0.85, and particularly within a range of between about 0.70 and 0.99. The cathode 101, as described in accordance with the previous embodiments, is suitable for reducing the rate of formation of conductivity-limiting compositions and extending the operable lifetime of the SOFC.

The stoichiometry of the cathode composition is further defined by the value of x. The value of x within the substituted lanthanum manganate composition represents the amount of the substituted species (A) within structure. According to one embodiment, x is not greater than about 0.5, such as not greater than about 0.4 or 0.3. Still, the concentration of A provided within the cathode 101 may be less, such that x is not greater than about 0.2, or still, not greater than about 0.1, and particularly within a range of between about 0.4 and 0.05. As previously discussed, according to a particular embodiment, A may be Sr such that the cathode composition is (La₁₋ₓSrₓ)_{y}MnO_{3-δ}, (LSM) where x is not greater than about 0.5, such as not greater than about 0.4, 0.3, 0.2 or even not greater than about 0.1.

In further reference to the lanthanum manganate cathode material, the ratio of La/Mn in the cathode 101 is generally altered by the reduction of La within the cathode material, such as by providing a substitutional species (the value of x in the general formula) as well as the creation of A-site vacancies (related to the value of y) within the lanthanum manganate crystal structure. According to one embodiment, the ratio of La/Mn is less than about 1.0, such as not greater than about 0.97, 0.95, or even not greater than about 0.93. According to a particular embodiment, the cathode 101 is LSM (substitution species is Sr) having a general composition of (La₁₋ₓSrₓ)_{y}MnO_{3-δ}, wherein x is not greater than about 0.5, y is not greater than about 1.0 and the ratio of La/Mn is less than about 1.0. Accordingly, the ratio of La/Mn within the LSM cathode may be less, such as not greater than about 0.97, 0.95 or even not greater than about 0.90. Generally, a ratio of La/Mn less than about 1.0, provides a suitable stoichiometric condition that reduces the formation of conductivity-limiting compositions and improves the operable lifetime of the SOFC.

Referring to the electrolyte layer 103, the electrolyte layer 103 is disposed between the anode 105 and cathode 1101. Suitable materials for the electrolyte layer 103 include zirconia, ceria, gallia, and other known ionic conductors. Oxygen ion conductivity is enhanced with oxide stabilizer materials such as yttrium, scandium, samarium, ytterbium and gadolinium. Suitable stabilizing materials include oxides such as TiO₂, CeO₂, CaO, Y₂O₃, MgO, Sc₂O₃, In₂O₃, and SnO₂. For example, the electrolyte layer 103 may be formed from yttria-stabilized zirconia, scandia-doped zirconia, ytterbia-doped zirconia, samarium oxide-doped ceria, gadolinium oxide-doped ceria, or calcia-doped ceria, among others.

According to one embodiment, the material of the electrolyte layer 103 is yttria-stabilized zirconia (YSZ). According to a particular embodiment, the electrolyte layer 103 comprises not greater than about 12 mol % yttria stabilizer within a zirconia matrix. Still in another embodiment, the electrolyte layer 103 comprises not greater than about 10 mol. % yttria, such as not greater than about 8.0 mol % or even about 6.0 mol % yttria stabilized in the zirconia matrix.

The electrolyte layer 103 further includes an electrolyte dopant 106. Provision of an electrolyte dopant 106 aids in improving the lifetime of SOFC by inhibiting the migration of species from the cathode to the cathode/electrolyte interface which results in the decomposition of the electrode. Additionally, the provision of the electrolyte dopant 106 reduces the formation of conductivity limiting compositions at the cathode/electrolyte interface, thereby extending the lifetime of the SOFC.

The effects of substitutional species in electrodes have been investigated in search of a means for improving conductivity. For example, in the context of mixed ionic-electronic electrode compositions (in contrast to an SOFC electrolyte layers), YSZ and was doped with Mn (or an Mn containing species) to investigate the solubility limit of Mn containing species within YSZ and the effects of Mn on the conductivity of the YSZ electrode. In particular, this investigation teaches that the formation of a two-phase composition of Mn and YSZ improves the total conductivity of the YSZ electrode composition due to an increase in the electronic conductivity in contrast to ionic conduction (the primary form of conduction in an SOFC electrolyte layer). See, Kim and Choi, “Mixed ionic and electronic conductivity of [(ZrO₂)_{0.92}(Y₂O₃)0.0₈]_{1-y}(MnO_{1.5})_{y}” Solid State Ionics, Elsevier (2000), available at www.elsevier.com/locate/ssi. Other references have developed use of a metal dopant species in an SOFC cathode (i.e., not an electrolyte layer) to increase oxygen-site vacancies and improve oxygen ion conductivity. See, for example, U.S. Pat. Nos. 6,521,202 and 6,821,498. Additionally, other references have described the use of a dopant in the electrolyte layer, and particularly disclose the use of titanium or terbia in the electrolyte to produce a n-type or p-type mixed-conduction region within the electrolyte layer to improve conductivity. See, for example, U.S. Pat. No. 5,518,830. However, such references are focused on improving the conductivity of the electrode or electrolyte, and do not address inhibiting the decomposition of the electrode material by reducing the migration of species to the cathode/electrolyte interface, particularly in the context of a fuel cell having an A-site deficient cathode material and an electrolyte dopant according to particular embodiments herein.

As previously described, the electrolyte dopant 106 includes a cation species of the cathode material. According to a particular embodiment, the electrolyte dopant 106 includes a cation species, such as Mn. Additionally, the electrolyte dopant 106 may be combined with an oxide to form oxide-containing species, for example, Mn₂O₃, or Mn₃O₄. Generally, the electrolyte dopant 106 is provided in a concentration such that the electrolyte layer is a solid solution. According to one embodiment, the electrolyte layer 103 is a single phase solid solution comprising the electrolyte dopant 106 and the base material. Accordingly, the concentration of the electrolyte dopant 106 within the electrolyte layer 103 is not greater than about 6.0 mol %, such as not greater than about 5.0 mol %, for example 4.0 mol %, or even 3.0 mol %. Still, the concentration of electrolyte dopant 106 may be less, such as 2.0 mol %, or even 1.0 mol %. The concentration of electrolyte dopant 106 within the electrolyte layer 103 is balanced such that, in conjunction with the above-disclosed compositions of the cathode material, the rate of migration of species within the cathode to the cathode/electrolyte interface is reduced thereby improving the lifetime of the SOFC.

Accordingly, the provision of an Mn containing species as the electrolyte dopant 106 in the electrolyte layer 103 reduces the rate of diffusion of Mn from the electrode (i.e., the cathode) and reduces the rate of diffusion of subsequent species from the electrode to the electrode/electrolyte interface during operation of the SOFC. According to one embodiment, Mn diffuses into the electrolyte layer 103 from the cathode at a rate of not greater than about 5×10⁻¹⁴ m²/s during operation of the fuel cell component. According to another embodiment, the rate of diffusion of Mn into the electrolyte form the cathode is not greater than about 1×10⁻¹⁵ m²/s or even 1.0×10⁻¹⁶ m²/s during operation of the fuel cell component.

According to a particular embodiment, illustrated in FIG. 1, the electrolyte dopant 106 is provided at a surface of the electrolyte layer 103 adjacent the cathode 101. According to one embodiment, the electrolyte dopant 106 is provided in the electrolyte layer 103 such that the electrolyte dopant 106 extends a distance into the electrolyte layer 103 not greater than about 5.0 microns. According to another embodiment, the electrolyte dopant 106 extends a distance not greater than about 4.0 microns into the electrolyte layer 103, such as not greater than about 3.0 microns, 2.5 microns, or even not greater than 2.0 microns.

The electrolyte dopant 106 may be provided in the electrolyte layer 103 by various methods, such as deposition, printing techniques, plating techniques, or film growth techniques. Alternatively, the cation species may be provided at the surface of the electrolyte layer 103 via ion implantation or other chemical implant techniques, or a combination of techniques, such as, for example a deposition and a thermal anneal. Still, the formation of a layer of electrolyte dopant 106 at the surface of the electrolyte layer 106 may be formed during formation of the electrolyte layer 103.

According to another embodiment, the transference number of the electrolyte layer 103 including the electrolyte dopant 106 is not less than about 1.0. The transference number is a measure of the primary mechanism of conduction within the electrolyte layer, that is, ionic or electronic. A transference number greater than or equal to about 1.0 indicates that the primary mechanism of conduction within the electrolyte layer 103 is ionic conductivity. In accordance with the embodiments above, the electrolyte dopant 106 can be provided within the electrolyte layer 103 such that ionic conductivity is the primary conduction mechanism and the transference number is not less than about 1.0, which may not necessarily enhance or maximize the total conductivity.

Additionally, the electrolyte dopant 106 within the electrolyte layer 103 in conjunction with the particular compositions of the cathode, inhibits the formation of conductivity-limiting compositions at the interface of the cathode 101 and the electrolyte 105. According to one embodiment, the rate of formation of conductivity limiting compositions is reduced by not less than about 20% during the first 10,000 hours of operation of a fuel cell having the electrolyte dopant, in comparison to a fuel cell component without the electrolyte dopant. Still, the rate of formation of such conductivity limiting compositions may be further reduced, such as by not less than about 30%, 40%, or even 50% during the first 10,000 hours of operation. According to another embodiment, the formation of conductivity limiting compositions is reduced by a rate of not less than about one order of magnitude during operation of the fuel cell at 1000° C. in comparison to fuel cells that do not include the dopant electrolyte 106. For example, the formation of conductivity limiting compositions is reduced by a rate of not less than 1.5 orders of magnitude, such as not less than about 2.0 orders of magnitude.

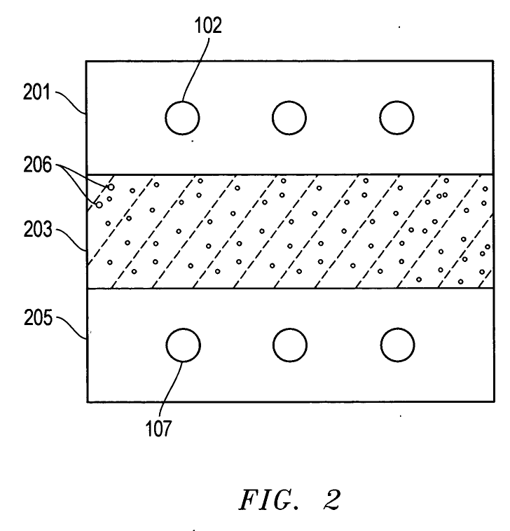

Referring to FIG. 2 and according to another embodiment, an electrolyte dopant 206 is dispersed throughout or substantially throughout an electrolyte layer 203, as illustrated in FIG. 2. According to one embodiment, the concentration of electrolyte dopant 206 in the electrolyte layer 103 is not greater than about 6.0 mol %, such as not greater than about 5.0 mol %, 4.0 mol % or even 3.0 mol %. Still, the concentration of electrolyte dopant 206 throughout the electrolyte layer 102 can be less, such as not greater than about 2.0 mol % or even 1.0 mol %.

According to another embodiment, a fuel cell stack can be made which incorporates multiple fuel cells. Each fuel cell of the fuel cell stack has a cathode comprising the previously discussed A-site deficient, doped lanthanum manganate material and an anode, as well as an electrolyte layer disposed between the cathode and the anode and comprising an electrolyte dopant material.

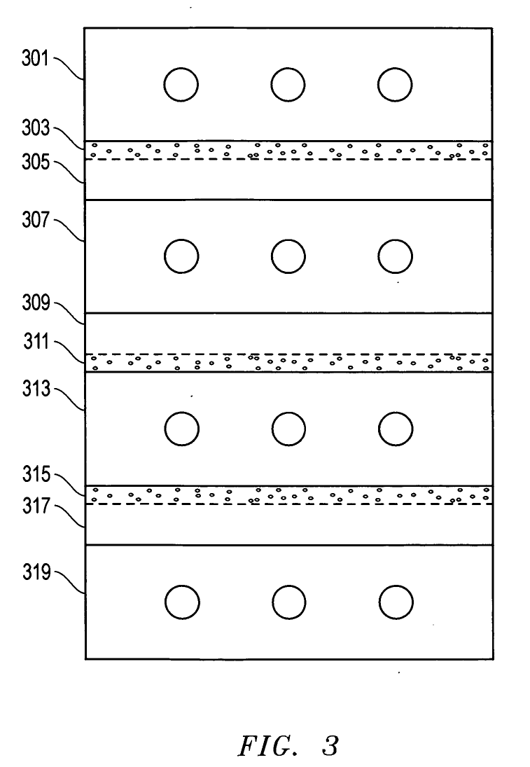

FIG. 3 illustrates a fuel cell stack having a plurality of fuel cells in accordance with embodiments provided herein. According to one embodiment, the combination of fuel cells facilitates the sharing of electrodes, such as the anode and the cathode between individual fuel cells. The stack includes electrode layers 301, 307, 313 and 319 separated by electrolyte layers 305, 309 and 317. As described in accordance with previous embodiments, each electrolyte layer includes an electrolyte dopant, which can be provided near a surface of an electrolyte layer or substantially throughout an electrolyte layer. For the purposes of illustration in FIG. 3, the electrolyte dopant of layers 303, 311 and 315 is illustrated as a surface layer or interfacial region within the electrolyte layers adjacent the cathode layers, such as in contrast to species within the cathode layers.

In one particular embodiment, electrode 301 is a cathode and electrode 307 is an anode with electrolyte layer 305 and an electrolyte dopant layer 303 adjacent the cathode 301 to form a single solid oxide fuel cell. It will be appreciated that another single solid oxide fuel cell is defined by electrode 307, which as stated previously is an anode, electrolyte layer 309, electrolyte dopant layer 311, and electrode 313, which is a cathode. As illustrated in the exemplary embodiment, each of the individual fuel cells shares an electrode, for example electrode 307 supplies gas to electrolyte layers 305 and 309. Additionally, electrode 313, which according to the illustrated embodiment is a cathode, supplies oxygen-rich gas to electrolyte layer 309 and 317. The stack may be arranged in a repeating pattern so that several electrodes are shared among adjacent solid oxide fuel cells. This configuration removes reliance upon use of gas-impermeable interconnect barriers, and is generally an electronically parallel design. However, the stack may alternatively be formed with gas impermeable interconnects. In this configuration, the arrangement of cells lends itself to a series circuit configuration of a solid oxide fuel cell stack. The stack may be connected to other stacks in a series, parallel or hybrid series/parallel circuit configuration.

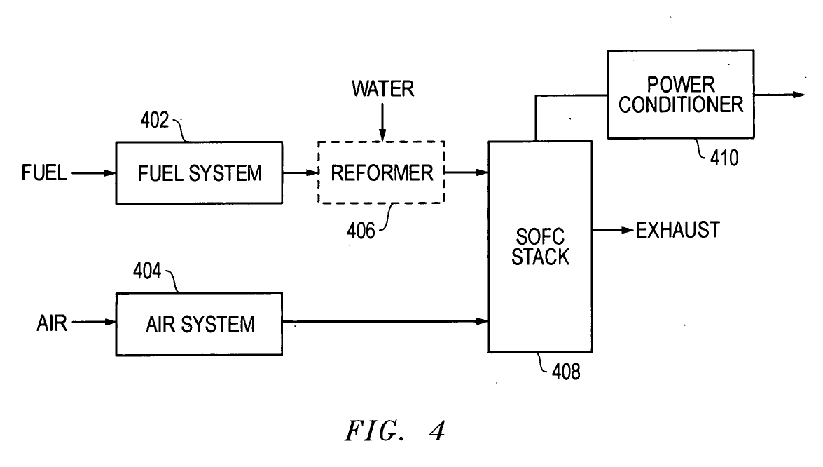

The solid oxide fuel cells described above may be incorporated into a SOFC system for producing power. FIG. 4 depicts an exemplary SOFC system. The system includes a fuel system 402, an air system 404, a SOFC stack 408, and a power conditioner 410. The system may also include a reformer 406 depending on the expected operating temperature of the SOFC stack.

Fuel enters the fuel system 402. The fuel system 402 may clean the fuel and/or heat the fuel in preparation for reforming or reaction. The fuel system 402 may include heat exchangers, compressors, pumps, absorption beds, and other components. From the fuel system 402, the fuel enters a reformer 406. The reformer 406 may use the fuel to produce hydrogen and other molecules. The reformer 406 is typically used for low temperature SOFC systems. High temperature SOFC systems may have the advantage of internal reforming and thus utilize unreformed fuel.

In this particular embodiment, the oxygen-rich gas is air, which enters the system through the air system 404. The air system 404 may clean, compress, purify, and/or heat the air. The air system may include compressors, absorption beds, membranes, and heat exchangers, among other components.

The fuel and air are directed to the SOFC stack 408. The fuel is typically directed across the anodes of the fuel cells in the SOFC stack and the air is typically directed across the cathodes. In the case of SOFCs, oxygen ion transport across the electrolyte from the cathode to the anode produces an electric potential. This electric potential is conditioned with a power conditioner 410 that is electrically coupled to the SOFC stack 408. The power conditioner 410 may deliver power to a grid or circuitry. Exhaust from the SOFC stack may be used for heat exchange or in the reformation process.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A fuel cell component comprising:
a cathode comprising a ceramic material, the ceramic material having an A-site deficient, perovskite crystal structure and comprising a cation species bonded to oxygen;
an anode; and
an electrolyte layer disposed between the cathode and the anode, the electrolyte layer comprising a base material and an electrolyte dopant, wherein the electrolyte dopant comprises the cation species of the cathode.

2. The fuel cell component of claim 1, wherein the base material comprises a material selected from the group consisting of zirconia, ceria, and gallia.

3. The fuel cell component of claim 2, wherein the base material further comprises a stabilizing material selected from the group consisting of TiO₂, CeO₂, CaO, Y₂O₃, MgO, Sc₂O₃, In₂O₃, and SnO₂.

4. The fuel cell component of claim 3, wherein the base material comprises yittria stabilized zirconia (YSZ).

5. The fuel cell component of claim 4, wherein the base material comprises not greater than about 12 mol % Y₂O₃ in ZrO₂.

6. (canceled)

7. The fuel cell component of claim 1, wherein the electrolyte layer comprises a single phase solid solution of the electrolyte dopant and the base material.

8. The fuel cell component of claim 7, wherein the cation species of the cathode is Mn.

9.-10. (canceled)

11. The fuel cell component of claim 8, wherein the electrolyte dopant extends a distance into the electrolyte layer not greater than about 2.5 microns.

12. The fuel cell component of claim 8, wherein the electrolyte layer has a transference number not less than about 1.0

13. The fuel cell component of claim 12, wherein the surface of the electrolyte layer has a concentration of electrolyte dopant not greater than about 6.0 mol %.

14.-19. (canceled)

20. The fuel cell component of claim 1, wherein the cathode comprises a porous material, the percent porosity of the cathode is not less about 15 vol. % of the total volume of the cathode.

21. The fuel cell component of claim 1, wherein the cathode comprises a lanthanum manganate material having a composition of (La₁₋ₓAₓ)_{y}MnO_{3-δ} wherein y is less than about 1.0, x is not greater than about 0.5, and the ratio of La/Mn is less than about 1.0.

22. The fuel cell component of claim 21, wherein the cathode composition is (La₁₋ₓAₓ)_{y}MnO_{3-δ}, wherein y is not greater than about 0.95, x is not greater than about 0.5, and the ratio of La/Mn is less than about 1.0.

23. The fuel cell component of claim 22, wherein the cathode composition is (La₁₋ₓAₓ)_{y}MnO_{3-δ}, wherein y is not greater than about 0.85, x is not greater than about 0.5, and the ratio of La/Mn is less than about 1.0.

24. The fuel cell component of claim 1, wherein the cathode composition is (La₁₋ₓAₓ)_{y}MnO_{3-δ}, wherein A is selected from the Mg, Ba, Sr, Ca, Co, Ga, Pb, and Zr.

25. The fuel cell component of claim 24, wherein A is Sr.

26. The fuel cell component of claim 24, wherein the cathode composition is (La₁₋ₓSrₓ)_{y}MnO₃, wherein y is less than about 1.0, x is not greater than about 0.5, and the ratio of La/Mn is less than about 1.0.

27.-31. (canceled)

32. The fuel cell component of claim 1, wherein the cathode, anode and electrolyte layer form a fuel cell, the component comprising multiple fuel cells in the form of a stack, the cathode of each comprising a lanthanum manganate material having a composition of (La₁₋ₓAₓ)_{y}MnO_{3-δ}, wherein y is less than about 1.0.

33. A fuel cell component comprising:
a cathode comprising a ceramic material, the ceramic material having an A-site deficient, perovskite crystal structure comprising manganese;
an anode comprising a cermet material; and
an electrolyte layer disposed between the cathode and the anode, the electrolyte layer comprising a base material and an electrolyte dopant, the electrolyte dopant comprising manganese.

34. The fuel cell component of claim 33, wherein the base material comprises a material selected from the group consisting of zirconia, ceria, and gallia.

35. (canceled)
